(19) United States
(12) Patent Application Publication
(10) Pub. No.: US 2016/0026809 A1
(43) Pub. Date: Jan. 28, 2016

(54) NETWORK BASED COLLABORATIVE INTERACTIVE DEVICES

(71) Applicant: PROMETHEAN LIMITED, Blackburn Lancashire (GB)

(72) Inventor: Andrew Edwardson, Bradford (GB)

(21) Appl. No.: 14/443,306

(22) PCT Filed: Nov. 15, 2013
(86) PCT No.: PCT/EP2013/073984

§ 371 Date: May 15, 2015

(30) Foreign Application Priority Data
Nov. 16, 2012 (GB) 1220643.9

(51) Int. Cl. G06F 21/62

(52) U.S. Cl. CPC G06F 21/62; G06F 2221/2141

(57) ABSTRACT

There is disclosed a method of establishing a communication network for connecting a plurality of computing devices, comprising: establishing a network under the control of one of the computing devices; running an application on at least one of the computing devices; and controlling access to an application running on a device by at least one other device by defining an access setting for each application running on device.

### CROSS-REFERENCE TO RELATED APPLICATIONS

This application is the National Stage of International Application Serial No. PCT/EP2013/073984, filed Nov. 15, 2013, which claims the benefit of United Kingdom Application Serial No. GB1220643.9, filed Nov. 16, 2012, the entire disclosures of which are incorporated by reference herein.

### BACKGROUND TO THE INVENTION

1. Field of the Invention

The present invention relates to collaborative interactive activity among a plurality of interactive devices. The invention is particularly, but not exclusively, related to collaborative interactive activity in a classroom environment.

2. Description of the Related Art

Interactive devices are well-known in the art, and include interactive whiteboards.

It is known to use interactive devices for collaborative activities. Typically collaborative activities allow multiple users to collaborate at a single interactive device.

It is an aim of the invention to improve the possibilities for interactive collaboration amongst multiple users.

### SUMMARY OF THE INVENTION

In accordance with the invention there is provided a method of establishing a communication network for connecting a plurality of computing devices, comprising: establishing a network under the control of one of the computing devices; running an application on at least one of the computing devices; and controlling access to an application running on a device by at least one other device by defining an access setting for each application running on each device.

The method may comprise establishing a connection between a plurality of computing devices.

The network may be a personal area network, PAN.

A session may be established between two or more applications, content being shared between applications in the session.

Content made available by an application may be transmitted to all applications having access to that application.

Each device may be configured to be associated with a predetermined network, wherein on determination of the presence of the predetermined network the device connects to the network automatically.

On connection with the network, a device may receive a list of other devices connected to the network. On connection with the network, a device may receive a list of applications running on other devices for which the device is permitted access.

Each device may be associated with a user, the access settings for an application running on a device being defined by the user.

The access settings for all applications on a device may be the same. The access settings for each application on a device may be unique.

The connection of a device to the network may be dependent upon a characteristic of the device. The characteristic may be a functionality to automatically register with a network of the predetermined type.

Access to an application on another device may be dependent on a characteristic of a user of the device. The characteristic may be the identity of the user.

The provision of access to an application may allow the provision of access to a peripheral device associated with the device in which the application is running

A registered device may register any peripheral devices associated therewith.

Further in accordance with the invention there is provided a system for a communication network for connecting a plurality of computing devices, comprising: at least one of the computing devices running an application; and adapted to control access to the application running on the device by at least one other device by defining an access setting for each application running on each device.

Embodiments of the invention are based on the principle that: (i) a device is a hub of a network (preferably but not necessarily a personal area network); (ii) other devices can join/register with the network (preferably but not necessarily automatically); and (iii) users of registered devices can register with applications on other devices (or more specifically, an application running on a user's device can register with an application running on another device in the network). The process for applications registering with each other comprises some permission-based processing.

### BRIEF DESCRIPTION OF THE FIGURES:

The invention is now described by way of example with reference to the accompanying figures in which:

FIG. 1 illustrates a network comprising a plurality of networked devices;

FIG. 2 illustrates an exemplary implementation of devices in a network arrangement such as FIG. 1, in a classroom environment;

FIGS. 3(a) and 3(b) illustrate exemplary process flows in an embodiment of the invention for registering in a network;

FIGS. 4(a) and 4(b) illustrate information stored in a network connected device in an embodiment of the invention;

FIGS. 5(a) and 5(b) illustrate process flows for accessing shared applications in an embodiment of the invention;

FIGS. 6(a) and 6(b) illustrate implementation architectures of a user device and a hub device in an embodiment of the invention;

FIG. 7 illustrates a further exemplary implementation of devices in a network arrangement; and

FIG. 8 illustrates a further exemplary implementation of information stored in a network device in the arrangement of FIG. 7.

### DESCRIPTION OF PREFERRED EMBODIMENTS

The invention is described herein by way of reference to exemplary implementations and preferred examples. In particular the invention is described in the context of collaborative working in a classroom environment, with users comprising students and/or teachers. The invention is not limited in its applicability to a classroom environment, and one skilled in the art will appreciate the broader applicability of the invention.

Similarly use cases described herein to illustrate aspects and/or embodiments of the invention are set out in the context of educational use-cases in a classroom related environment. One skilled in the art will appreciate the broader applicability of such use cases, and alternative use cases.

The invention is described in the following in an arrangement in which a dedicated hub device is provided. However the invention is not so limited, and in embodiments one or more devices may provide the hub functionality.

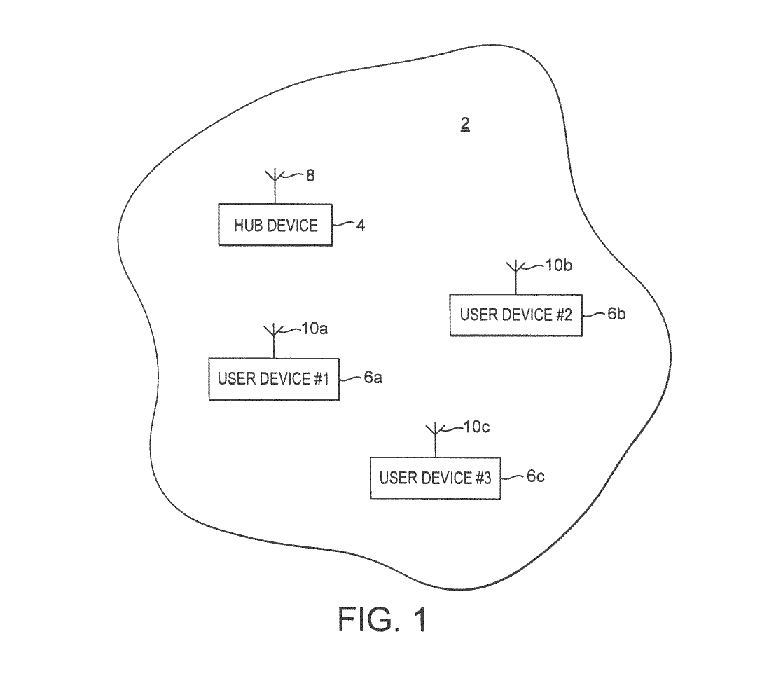

FIG. 1 illustrates an exemplary network and devices connected to such network in accordance with a preferred embodiment of the invention.

A wireless network is denoted by reference numeral 2. The reference numeral 2 denotes the range of the wireless network such that wireless devices within the area 2 can transmit/receive signals to/from the wireless network, and devices outside the area 2 cannot connect transmit/receive signals to/from the wireless network. The invention is not limited to use in conjunction with a wireless network, and may be implemented with the provision of a wired network. However a wireless network is envisaged as the most useful implementation. In general the wireless network may be a communications network.

In a particularly preferred implementation the wireless network is a personal area network, PAN. A PAN has particular advantages in embodiments of the invention due to its reliability and speed of operation. In implementations where speed of communication between networked devices is critical, the use of a PAN is advantageous. However any type of wireless network may be used for implementation of the invention, according to the requirements of the implementation. The speed of the network will be implementation dependent.

Illustrated in FIG. 1 within range of the wireless network 2 is a hub device 4 for this embodiment having an antenna 8 for wireless communication. In accordance with embodiments of the invention, as will be understood from the following description, the hub device acts as a hub for communications between other devices. In the described exemplary arrangement the hub device 4 generates and controls the wireless network 2.

Further illustrated in FIG. 1 within range of the wireless network 2 is a plurality of user devices for this embodiment denoted by reference numerals 6a, 6b, 6c each having a respective antenna 10a, 10b, 10c. The users devices 6a, 6b, 6c are also respectively labelled ‘user device #1’, ‘user device #2’, and ‘user device #3’ in the Figures. Each user device is preferably associated with at least one user, not shown in FIG. 1.

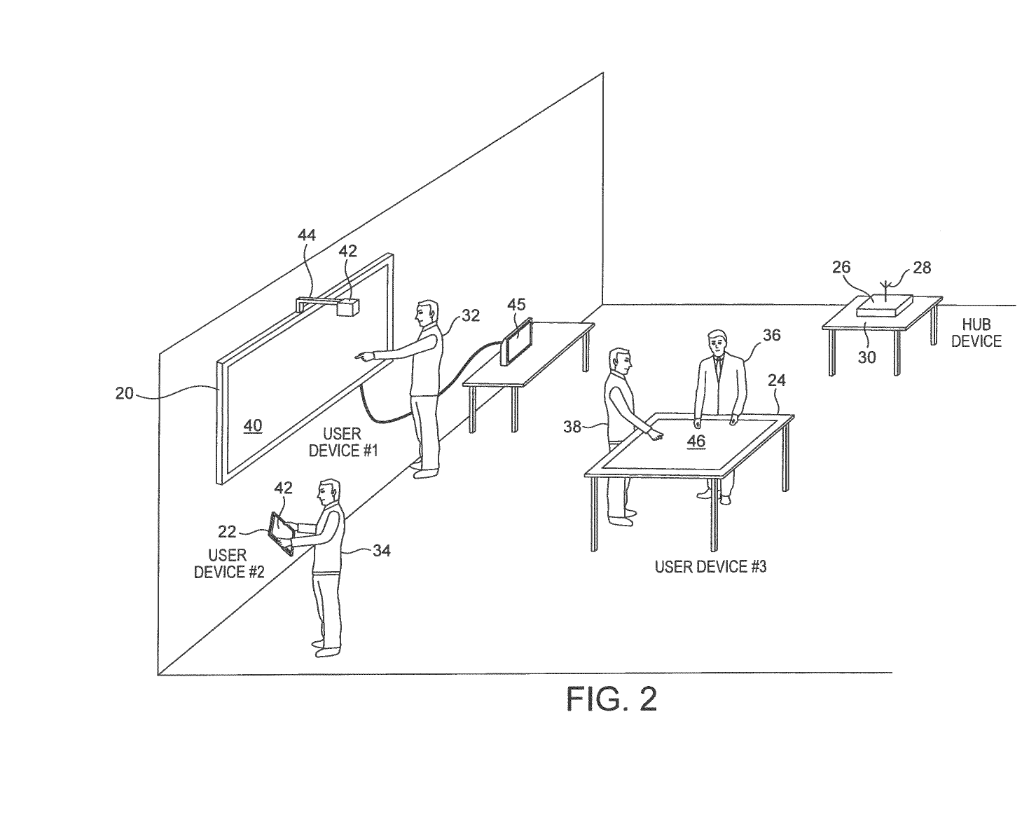

With reference to FIG. 2, there is illustrated an exemplary implementation in which embodiments of the invention are described. FIG. 2 illustrates, for the exemplary implementation, examples of the user devices of FIG. 1.

FIG. 2 illustrates a classroom including an interactive electronic whiteboard 20 which represents ‘user device #1’, a handheld interactive device 22 representing ‘user device #2’, an interactive table 24 representing ‘user device#3’, and a hub device 26 with associated antenna 28 corresponding to hub device 4 illustrated as positioned on a table 30.

Interactive electronic whiteboard 20 may be implemented in any number of ways, such devices being well-known in the art. In FIG. 2 the interactive electronic whiteboard 20 is illustrated as a device having a vertically-orientated interactive display surface 40 on which images are displayed and user inputs may be detected. The interactive display surface 40 may be a touch sensitive surface and/or have an underlying electromagnetic grid for detecting an electromagnetic device on the surface. The interactive display surface 40 may be an emissive display surface and/or a surface onto which images are projected. In the arrangement of FIG. 2 there is shown a projector device 42 positioned relative to the interactive display surface 40 by a boom arm 44, for projecting images onto the display. A computer system, illustrated by reference numeral 45 in FIG. 2, may be connected to the interactive electronic whiteboard 20 for control purposes.

In FIG. 2 a single user 32 is illustrated as providing inputs at the surface 40. It is known in the art that multiple users may provide inputs at a surface of an interactive electronic whiteboard, and the single user 32 of FIG. 2 is exemplary. A single user may also provide multiple inputs, for example by the use of two hands to provide touch inputs.

Embodiments of the invention are not limited to any particular type of interactive whiteboard or vertical interactive surface.

Handheld interactive device 22 may be implemented in any number of ways, such devices being well-known in the art. In FIG. 2 the handheld device 22 is illustrated as a tablet device, and has an interactive display surface 42 which is an emissive display and on which images are displayed and at which touch inputs can be detected. The handheld interactive device 22 may also be a mobile telephony device.

In FIG. 2 a single user 34 is illustrated as providing inputs at the surface 42. It is more typical for such a device that a single user will provide inputs. Such a device may be considered a personal device. A single user may also provide multiple inputs, for example by the use of two fingers to provide touch inputs.

Interactive table 24 may be implemented in any number of ways, such devices being well-known in the art. In FIG. 2 the interactive table is illustrated as having a horizontally disposed interactive display surface 46 which is an emissive display and on which images are displayed and at which touch inputs can be detected.

In FIG. 2 two users 36 and 38 are illustrated as providing inputs at the surface 46. It is known in the art that one or more users may provide inputs at a surface of an interactive table, and the two users 36 and 38 of FIG. 2 are exemplary. A single user may also provide multiple inputs, for example by the use of two hands or two fingers to provide touch inputs.

The exemplary hub device 26, for the purpose of the described examples, is a computing device having wireless access point functionality, to provide the wireless network hosting and control to allow the various user devices of FIG. 2 to communicate in accordance with embodiments of the invention, as described further below. However the functionality provided by the hub device 26 may be provided by one of the user devices, and a dedicated hub device is not a requirement. For the purposes of explanation, however, a dedicated hub device is described.

The wireless network 2 provides a communication network for connecting a plurality of computing devices, comprising in the described embodiment the user devices illustrated in FIG. 2 (and FIG. 1). The communications network is established under the control of one of the computing devices, such as a dedicated hub device as illustrated in FIG. 2 (and FIG. 1) where it is provided.

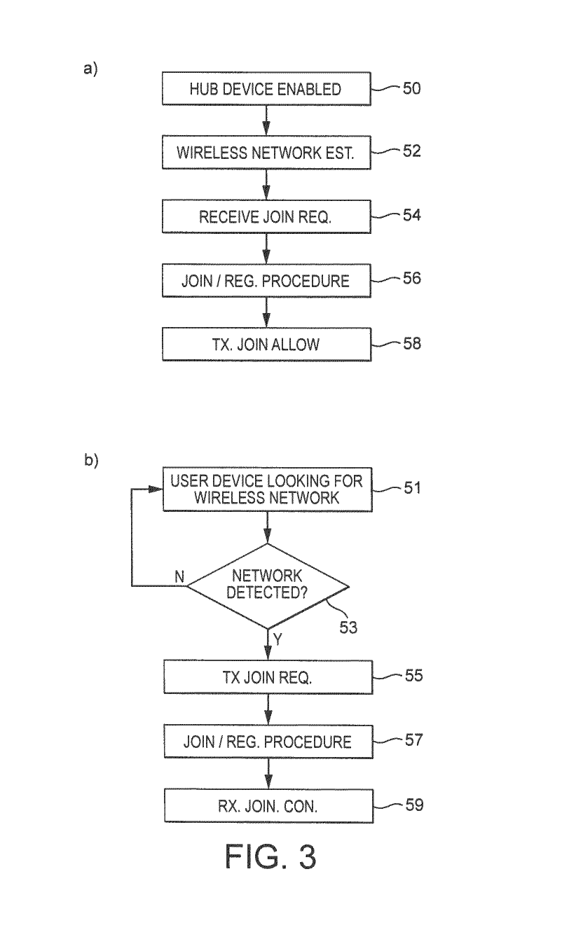

At least one further user device is connected to the network 2 by registering with the hub device 26. The at least one further user device may be any one of the illustrated user devices. Thus in order to join the wireless network 2, each user device must register with the hub device. With reference to FIG. 3(a), a process at the hub device 26 for establishing the wireless network and registering a user device with the network is illustrated, and with reference to FIG. 3(b) a process for a user device to register with the hub is illustrated.

In a step 50 of FIG. 3(a), the hub device 26 is enabled. On being enabled, as denoted by step 52 of FIG. 3(a), the wireless network 2 is established. It can be noted that the hub device 26 is not required to be additionally connected to any other network. The purpose of the network established by the hub device is to interconnect the user devices of FIG. 2 (and FIG. 1).

With reference to FIG. 3(b), in a step 51 a user device having wireless capability is switched on and set to detect the presence of wireless networks as known in the art. In a step 53 it is determined whether a network is detected. If not, then the process iterates through steps 51 and 53. If a wireless network is detected, then in a step 55 the user device sends a request to join the network to the hub device. With reference to FIG. 3(a), the hub device receives the request to join in a step 54.

In accordance with known techniques, the steps 51 to 55 of FIG. 3(b) may be initiated manually under the control of the user of the user device. In an alternative arrangement the steps 51 to 55 of FIG. 3(b) may occur automatically without user control. In a particular preferred embodiment, the identity of the wireless network established by the hub device 26 may include an identifier identifying the wireless network of being a certain type. The user device may be adapted to automatically look for wireless network of that type, and attempt to register with wireless networks of that type.

In a step 56 of FIG. 3(a) and a step 57 of FIG. 3(b), the hub device and the user device communicate to allow an appropriate procedure for the use device to join and/or/register with the wireless network 2, in accordance with a particular implementation. As known in the art, this may involve the user device being required to provide a password. As known in the art the user device may have registered with the network previously, and have a pre-stored password, or the user may have to manually provide a password. The mechanism by which a user device connects with the wireless network is outside the scope of the present invention.

On successful registration of the user device with the network, the hub device transmits an acknowledgement that the request has been accepted and the user device has joined the network to the user device, as denoted by step 58 in FIG. 3(a). As denoted by step 59 in FIG. 3(b), the use device receives the acknowledgement as a conformation that it has joined the network from the hub device.

In accordance with the invention and its embodiments, functionality is provided to allow each user device to make available content and/or control of applications running on the user device to other user devices in the network. Each user device is associated with one or more applications, and each user device may allow access to is application by other user devices, and may access the applications of other user devices. Such access is preferably controlled, such that there are access settings associated with each application or application content which permit/restrict access.

Thus, an application is run on at least one of the computing devices; and access to an application running on a device by other devices is controlled by defining access settings for each application running on each device, as will now be further described.

An example is described.

It is assumed that ‘user device #1’, in the exemplary scenario the interactive electronic whiteboard 20 of FIG. 1, is registered with the network 2. A number of applications are running on the interactive electronic whiteboard 20, under the control of the computer 46 with which it is associated. For example, two applications ‘IEW application #1’ and ‘IEW application #2’ are running on the interactive electronic whiteboard 20.

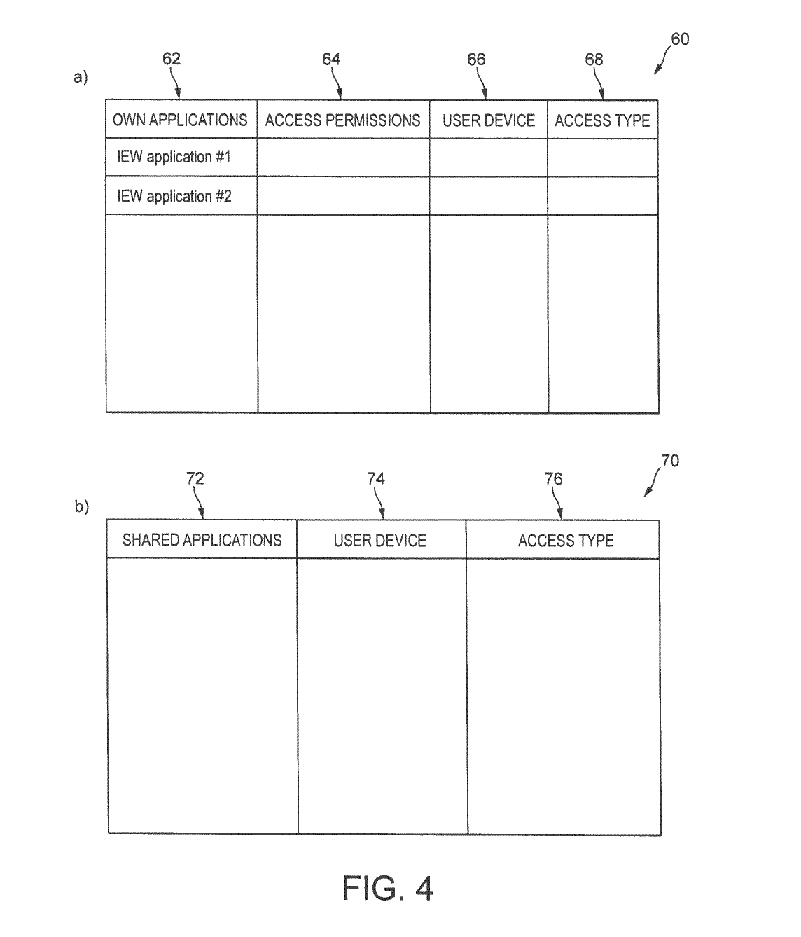

With reference to FIGS. 4(a) and 4(b), there are illustrated tables associated with the interactive electronic whiteboard 20 and reflecting in particular the application status of the interactive electronic whiteboard 20.

As shown in FIG. 4(a) a first table 60 represents applications running on interactive electronic whiteboard itself

In a first column 62 headed ‘own applications’ there is listed an identity of the current applications running on the interactive electronic whiteboard 20. This column lists in two rows ‘IEW application #1’ and ‘JEW application #2’.

In a second column 64 of the first table there is illustrated the access permissions associated with each of the interactive electronic whiteboard applications. The interactive electronic whiteboard 20 may set the access permissions according to any number of criteria. For example access may be public, requiring no authorisation. Access may be restricted by password. Access may be restricted by type of device. Access may be restricted by type of user.

In a third column 66 of the first table there is illustrated the user devices that are currently provided with access to each of the applications.

In a fourth column 68 of the first table there is illustrated the type of access that the user devices in the third column have. The access may, for example, be restricted to ‘read only’, or may allow control of the application.

Access to an application running on a device may allow one device to assume control of another.

As shown in FIG. 4(b) a second table 70 represents applications running on other user devices that the interactive electronic whiteboard has been granted access to.

In a first column 72 headed ‘shared applications’ there is listed an identity of the current applications running on other user devices and to which the interactive electronic whiteboard 20 has access.

In a second column 74 of the second table there is illustrated the identities of the user device associated with each of the shared applications for the interactive electronic whiteboard 20.

In a third column 76 of the second table there is illustrated the type of access which the interactive electronic whiteboard 20 is permitted for each application. The access may, for example, be restricted to ‘read only’, or may allow control of the application.

It will be understood that each user device connected to the wireless network will typically have tables as shown associated in FIGS. 4(a) and 4(b) associated therewith. Whilst the exact tables shown may not be provided, functionality consistent with these tables will be provided.

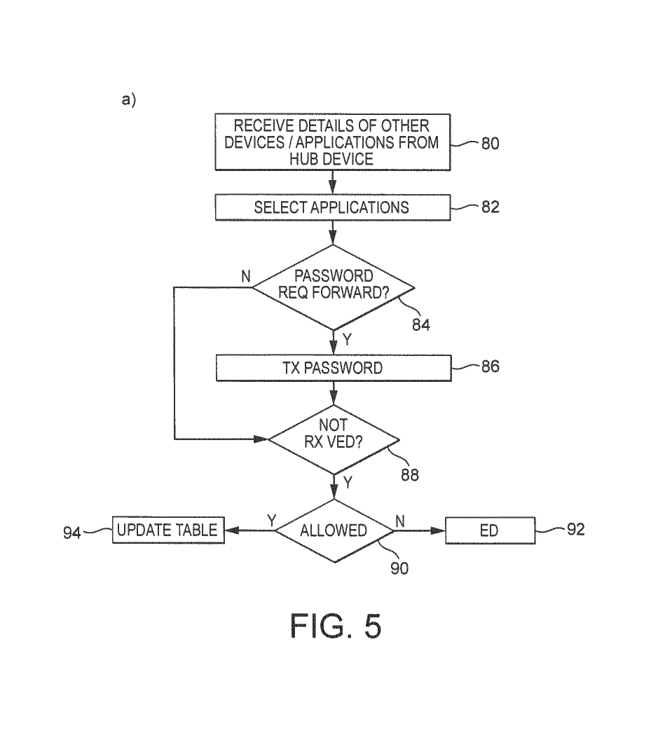

The creation and management of exemplary tables as shown in FIGS. 4(a) and 4(b) is now further described with reference to FIGS. 5(a) and 5(b).

It is assumed that each of the user devices shown in FIG. 2 is present in vicinity of the network and connected to the network. FIG. 5(a) illustrates the process, once registered with the network, associated with accessing applications running on devices in the network from the perspective of a user device requesting access. FIG. 5(b) illustrates the process from the perspective of a user device running the application to which access is requested.

In a step 80 of FIG. 5(a), following registration in the network, the user device receives a list of devices connected in the network and applications running on those devices which are available for access. In a preferred arrangement the hub device stores a mirror of the tables of FIGS. 4(a) and 4(b) of each user device, and provides the list to of availability devices and applications based on the mirrored tables.

Preferably the information provided to a user device also includes the access information associated with each application. In one embodiment the hub device provides a list of all the applications on all the devices to the user devices. In other embodiments the hub device may only provide a list of the applications to which a user device receiving the list has access.

Preferably the information provided to a user device also includes the type of access permitted.

In a step 82 of FIG. 5(b), the user device then selects a desired application. In a typical implementation, the selection will take place by a user selecting the application from a list or information displayed in a user interface of the user device.

In a step 81 of FIG. 5(b), a user device on which an application is running, which may be referred to as a host device, monitors for requests to access the application. It is assumed for this example the user device associated with the process of FIG. 5(a) selects in step 82 an application which is running on a user device associated with the process of FIG. 5(b), a request for access to which is received in step 83.

In a step 85 of FIG. 5(b), the host device determined whether the application to which access is requested has access setting such that access is public, i.e. unrestricted. If so, then access is allowed in step 87.

If access is not public, then in a step 89 of FIG. 5(b) it is determined whether access to the application is allowed for devices of a particular type or characteristic. If so, and the device making the request meets the characteristic, then access is allowed in step 87.

If access is not determined based on a device type or characteristic, or if the device making the request is not of the correct type or does not possess the correct characteristic, in step 93 of FIG. 5(b) it is determined whether access is password protected.

If so, then in step 95 of FIG. 5(b) the host device transmits a request for the password to the requesting device. In a step 84 of FIG. 5(a), the requesting device determines that a request for a password has been received, and then in step 86 transmits a password.

In a step 97 of FIG. 5(b) the host device determines if the requesting device has transmitted a password. If so, then in step 99 it is determined whether the password is correct. If so, the process in the host device in FIG. 5(b) progresses to step 87, and if not the process progresses to step 101.

If in step 93 it is determined that the application is not associated with password access, then the process in the host device moves on to step 101.

In step 101 it is determined to reject the access request. In step 87 it is determined to allow the access request. Following either of steps 101 and 87 the process in the host device proceed in FIG. 5(b) to step 103, and a notification concerning the request is transmitted to the requesting device. If the request has been allowed, following step 87 the host device also updates its own applications table, corresponding to FIG. 4(a).

In step 88 of FIG. 5(a), the requesting device awaits notification from the host device, and upon receipt in step 100 determines if the request has been allowed. If the request has been allowed, the requesting device updates its shared applications table, corresponding to FIG. 4(b). If the request is not allowed, then following step 90 in FIG. 5(a) the process in the requesting device is terminated in step 92.

The process described with reference to FIGS. 5(a) and 5(b) may be dynamic, with each user device receiving updates information as other user devices open and close applications. A user device may receive a list of current available applications by sending a request to the hub device, the selection of a further application at any time following the process described hereinabove.

In the event that any change is made to a table of any user device corresponding to the table so FIGS. 4(a) and 4(b), the user device preferably transmits an update message to the hub device to notify the hub device of the change.

When a user device is first connected in the network, a list of applications running on the user device is provided to the hub device so as it may be made available to the other user devices.

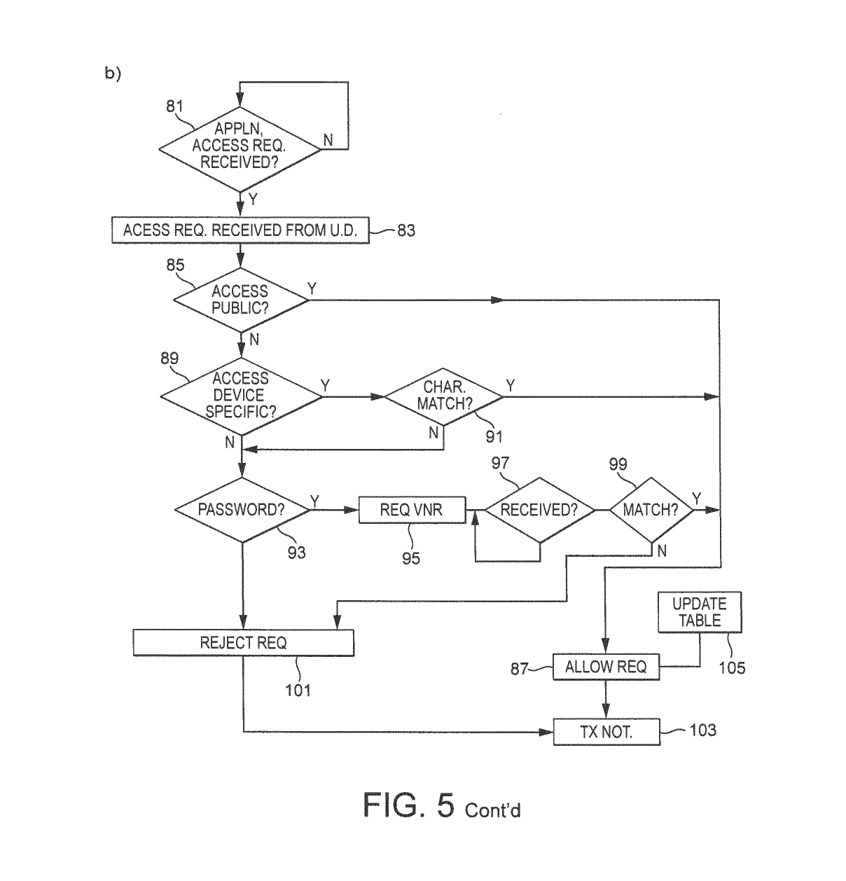

FIG. 6(a) illustrates an exemplary architecture of a hub device in accordance with an embodiment of the invention, such as hub device 4 of FIG. 1.

FIG. 6(b) illustrates an exemplary architecture of a user device in accordance with an embodiment of the invention, such as one of the user devices 6a, 6b, 6c of FIG. 1.

In the foregoing embodiment there has been described an arrangement in which a distinct hub is provided. This is described for illustration purposes, and in other embodiments a distinct hub is not provided. The functionality of the hub may be provided in a user device, or may be distributed between multiple user devices. In a particular embodiment the functionality of the hub may be dynamic, being provided by different user devices at different times, and/or spread amongst different user devices at different times. In practice the function of the hub may be achieved by a server, and the operation of the server may be provided on one user device or distributed on several user devices.

In the foregoing embodiment an arrangement is described in which applications are associated with the physical user devices with which they are assisted. This is achieved, in the foregoing embodiment, by the use of tables associated with individual user devices. In practice, such an association may be onerous.

In general, an application which may be controlled or accessed by one or more users may be termed an object, and control of the application or object may be termed a session.

In an alternative embodiment the object may be hidden or not hidden on the server.

The session which controls the object can be moved between user devices. For example, if a current host leaves the classroom, and hence the wireless area, another user device may take responsibility for hosting the session: i.e. the session moves to another user device. In such a scenario, each session has a unique identifier which identifies which user device is currently the host for the session.

This may involve the user device that is leaving sending a message to the network requesting another user device to assume responsibility for the session. When a user device is to leave a classroom, for example, whichever user device within the classroom that receives and responds to the message may take the session over for the device that is leaving. However the default operation may be that the session will ‘die’. The message from a user device that a user device is leaving may go to all user devices, those user devices that have access to the session, or one particular user device according to implementation requirements. For example, there may be master server within the network which will receive the message. This master server may define rules for the session. These rules may state that a user device should always pass on a session to the next available server. In a preferred embodiment, a master user device for a session is the user device which currently hosts the session, so the master user devices are distributed. When a user device leaves, the rules for that user device may determine the user device to which the session is to be transferred.

A current host device has the ability to change the rules. The rules may define any characteristics of the session.

The server does not have to be a host device.

The functionality of a server session and a user device are preferably separated.

In a preferred embodiment the servers may have the ability to see each other, but sessions may not. Sessions can only be exchanged from one user device to another is access rights permit such.

Sessions can be hierarchical. Sessions are an efficient way to keep connection of user devices managed and manage the joining of existing devices.

In embodiments, there may be provided multiple sessions for each user, with different access levels for each user.

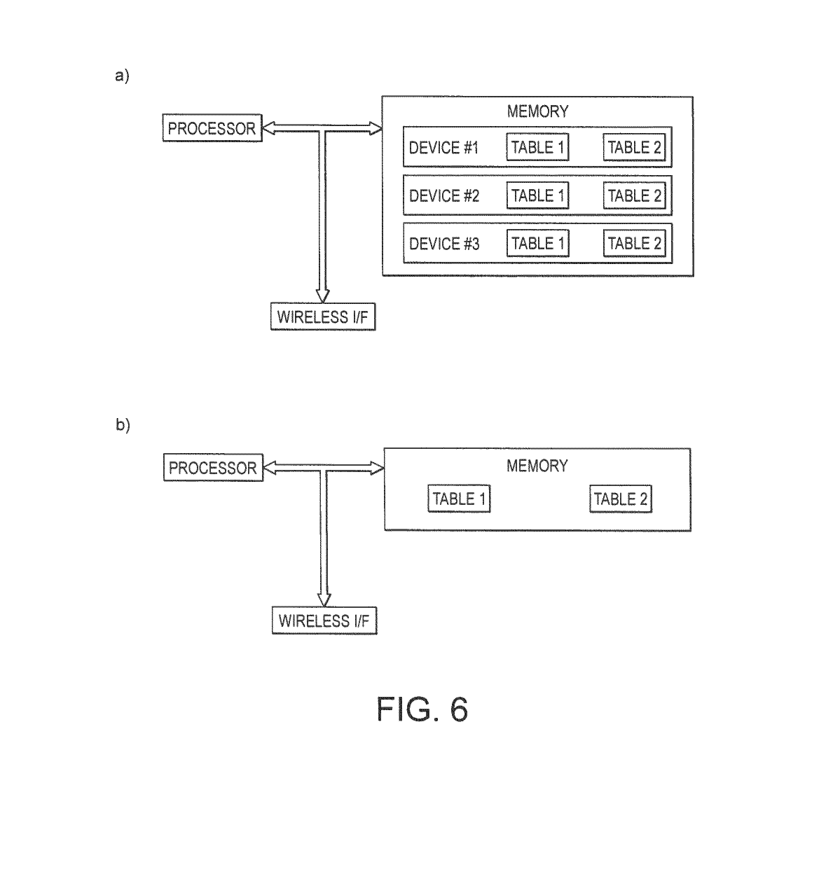

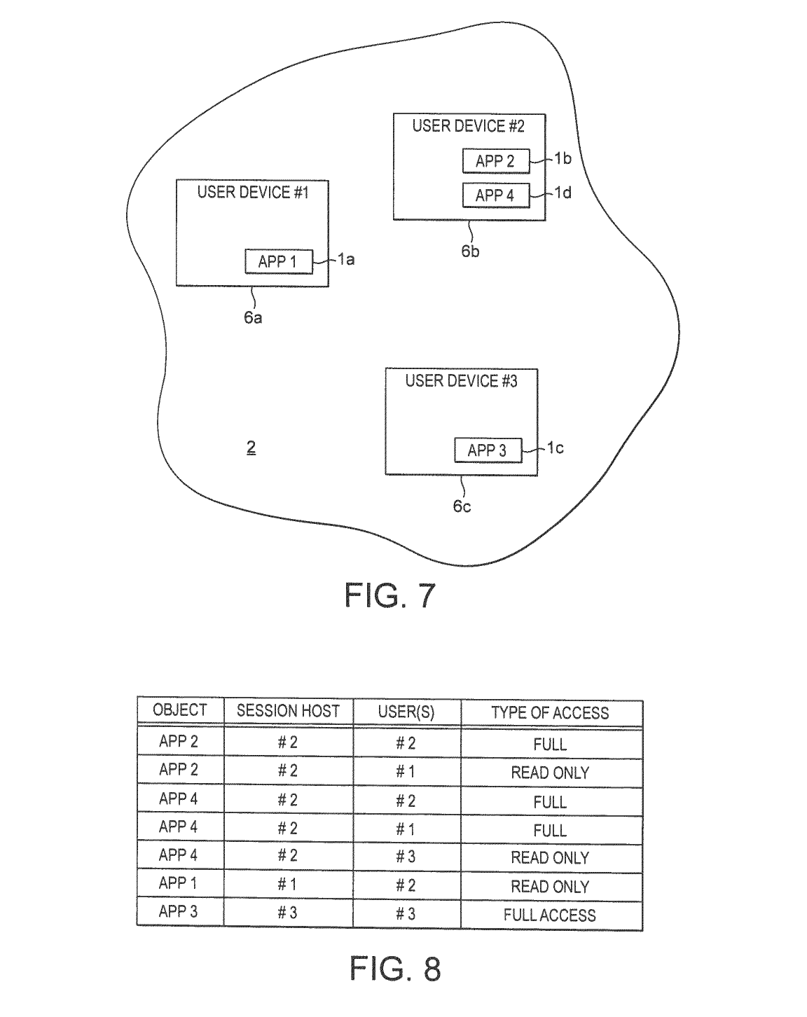

FIGS. 7 and 8 describe a further embodiment of the invention consistent with the foregoing. However one skilled in the art will appreciate that the implementation of the invention may be achieved in a number of ways.

With reference to FIG. 7, in this illustrative example there are three user devices 6a, 6b, 6c labelled ‘user device #1’, ‘user device #2’, and ‘user device #3’. Each user device potentially has one or more applications associated with it. The applications may be any software which can run on the device, including software which controls an interactive whiteboard. In the example shown, the first user device 6a has one application termed ‘appl 1’ denoted by reference numeral 1a, the second user device 6b has two applications ‘app 2’ and ‘app 4’ denoted by reference numerals 1b and 1d, and the third user device 6c has one application ‘appl 3’ denoted by reference numeral 1c.

In accordance with this embodiment of the invention, each user device is the host for the session associated with an application (object) running on that user device, and has a table which defines the access parameters for that application. In addition, the table for each user device defines the permissions for that user device to access objects of other user devices. This is illustrated in FIG. 8 with example to the user device #2, denoted by reference numeral 6b.

FIG. 8 shows an exemplary table for the second user device 6b. It can be seen that the table has headings ‘object’, ‘session host’, ‘user(s)’, and ‘type of access’. The ‘object’ column lists every application to which that user device has access. There may be other applications in the network, but only those applications are listed to which the user device has access. For each application or object, the ‘session host’ column defines the user device which is the host for that object. In accordance with this embodiment, the host will be the user device on which the application is running The ‘user(s)’ column defines those user devices which are associated with that application, and the ‘type of access’ column defines what type of access is permitted for that user.

As shown, the type of access may vary, and will be determined by the access requested and the host device. For example, only one device may have full control of an application at any time, and once full control is given any further user device requesting access is given only road-only rights.

The type of access may be more sophisticated. For example, the type of access may define that a user device is allowed full access once full access is completed by another device. The type of access may define that full access is given to another device once full access is completed by another device. The type of access may also define sending messages to user devices to advise that a type of access for the user is changed or become available.

An important aspect of the present invention is that rules are defined within a session for an object. These rules may be reflected in the ‘type of access’ column.

A user device preferably periodically broadcasts its presence. At the same time, a user device listens for broadcast messages. This allows user devices to join networks and sessions, and for sessions to be created, without specific requests to establish sessions. When a user device first joins a network, the user may be provided with a list of objects which it can request an association with. The implementation of this will be system specific.

There has thus been described a collaborative interactive system in accordance with various embodiments. One skilled in the art will appreciate that different aspects of different embodiments may be combined in order to achieve the present invention. The present invention is not limited to aspects of the foregoing embodiments as set out. One skilled in the art will appreciate that the invention may be implemented in different ways. The protection afforded by the present invention is set out in the appended claims.

1. A method of establishing a communication network for connecting a plurality of computing devices, comprising:
establishing a network between a plurality of computing devices under the control of one of the computing devices;
running an application on at least one of the computing devices; and
controlling access to an application running on a device by at least one other device by defining an access setting for each application running on each device.

2. (canceled)

3. (canceled)

4. The method according to claim 1 wherein a session is established between two or more applications, content being shared between applications in the session.

5. The method according to claim 1 wherein content made available by an application is transmitted to all applications having access to that application.

6. The method according to claim 1, wherein each device is configured to be associated with a predetermined network, wherein on determination of the presence of the predetermined network the device connects to the network automatically.

7. The method according to claim 1, wherein on connection with the network, a device receives a list of other devices connected to the network.

8. The method according to claim 1, wherein on connection with the network, a device receives a list of applications running on other devices for which the device is permitted access.

9. The method according to claim 1, wherein each device is associated with a user, the access settings for an application running on a device being defined by the user.

10. The method according to claim 1, wherein the access settings for all applications on a device are the same.

11. The method according to claim 1, wherein the access settings for each application on a device is unique.

12. The method according to claim 1, wherein the connection of a device to the network is dependent upon a characteristic of the device.

13. The method according to claim 12 wherein the characteristic is a functionality to automatically register with a network of the predetermined type.

14. The method according to claim 1, wherein access to an application on another device is dependent on a characteristic of a user of the device.

15. The method according to claim 14 wherein the characteristic may be the identity of the user.

16. The method according to claim 1, wherein the provision of access to an application allows the provision of access to a peripheral device associated with the device in which the application is running.

17. The method according to claim 1, wherein a registered device registers any peripheral devices associated therewith.

18. A system for a communication network for connecting a plurality of computing devices, comprising:
at least one of the computing devices running an application; and
adapted to control access to the application running on the device by at least one other device by defining an access setting for each application running on each device.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. The system according to claim 18 adapted to establish a session between two or more applications, content being shared between applications in the session.

36. The system according to claim 18 wherein each device is configured to be associated with a predetermined network, wherein on determination of the presence of the predetermined network the device connects to the network automatically.

37. The system according to claim 18 wherein on connection with the network, a device receives a list of other devices connected to the network.

38. The system according to claim 18 wherein on connection with the network, a device receives a list of applications running on other devices for which the device is permitted access.
